(19) United States
(12) Patent Application Publication
(10) Pub. No.: US 2024/0217315 A1
(43) Pub. Date: Jul. 4, 2024

(54) FLUSH DROPPABLE GLASS ASSEMBLY FOR A DOOR OR TAILGATE OF A VEHICLE

(71) Applicant: Rivian IP Holdings, LLC, Irvine, CA (US)

(72) Inventors: Philipp Wolf, Dana Point, CA (US); Jim Dowle, Laguna Beach, CA (US); Barry Lett, Woking (GB); Nicolas Tournier, Mission Viejo, CA (US); Marcus Merideth, Irvine, CA (US); Raghav Jaswal, Coventry (GB); Michael Castiglione, Carlsbad, CA (US)

(21) Appl. No.: 18/089,841

(22) Filed: Dec. 28, 2022

(51) Int. Cl. B60J 1/18; B60J 10/79

(52) U.S. Cl. CPC B60J 1/1861; B60J 10/79

(57) ABSTRACT

An assembly for a vehicle, including exterior and interior door panels forming a door body and a glass extending from a top of the door body in a closed configuration and being disposed within the door body in an open configuration, lower and upper corners of the glass including lower and upper protruding structures, respectively. An upper guide element is secured to or formed in a pillar of the vehicle and receives the upper protruding structure. A lower guide element is secured to or formed in an interior portion of the door body and receives the lower protruding structure, an upper portion of the lower guide element including a curved guide piece. When the lower protruding structure translates inboard through the curved guide piece and vertically downwards through the lower guide element, the upper protruding structure translates vertically downwards through the upper guide element.

### INTRODUCTION

The present disclosure relates generally to the automotive field.

Some sport utility vehicles (SUVs) and the like, for aesthetic purposes, include a rear door that utilizes fixed flush glass, where the glass is flush with an exterior panel of the rear door. Other SUVs and the like, for functional purposes, include a rear door or tailgate that utilizes droppable inset glass, where the glass is inset from (i.e. sub-flush with) the exterior panel of the rear door or tailgate. In either case, the rear door may include an exterior frame structure surrounding the glass/glass opening as well. In the droppable inset glass case, the glass is inset from (i.e., sub-flush with) the exterior panel of the rear door or tailgate such that the glass can drop vertically into the rear door or tailgate without interference from other structures and components disposed within the rear door or tailgate adjacent to the exterior panel, such as tail lamp assemblies, rear lighting modules, rear vent structures, latching assemblies, and the like. This inset configuration necessitates the use of stepped sheet metal for the exterior panel where the rear door or tailgate meets the glass and an associated exterior seal, which may not be desirable from an aesthetic perspective.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a flush droppable glass assembly for a door or tailgate of a vehicle. When in a closed configuration, the glass sits flush with an exterior panel of the door or tailgate. When transitioning to an open configuration, a bottom portion of the glass first translates inboard relative to the exterior panel, before translating vertically downwards into the interior of the door or tailgate. This prevents the glass from contacting other structures and components disposed within the interior of the door or tailgate adjacent to the exterior panel, such as lamp assemblies, lighting modules, vent structures, latching assemblies, and the like. Once the glass is in the open configuration and disposed within the interior of the door or tailgate, the door or tailgate may remain closed, or may be opened vertically or horizontally via appropriate hinges. Movement of the glass when transitioning from the closed configuration to the open configuration is guided and constrained by several guide elements, described in greater detail herein. In the tailgate embodiment provided, the tailgate is pivotable around a lower edge of the tailgate and does not utilize any exterior frame structure surrounding the glass/glass opening. It will be readily apparent to those of ordinary skill in the art that the concepts and principles of the present disclosure may applied to any type of vehicle door equally, whether a rear, front, or side door, whether pivoting downwards, upwards, or sideways, whether having exterior framed or frameless glass, etc. Thus, “door” and “tailgate” are used interchangeably herein.

In one illustrative embodiment, the present disclosure provides an assembly (door, tailgate, and glass) for a vehicle, the assembly including: an exterior door panel and an interior door panel forming a door body; a glass adapted to extend from a top of the door body in a closed configuration and be disposed within the door body in an open configuration, wherein a lower corner of the glass includes a lower protruding structure and an upper corner of the glass includes an upper protruding structure; an upper guide element adapted to be secured to or formed in a pillar of the vehicle and receive the upper protruding structure; and a lower guide element adapted to be secured to or formed in an interior portion of the door body and receive the lower protruding structure, wherein lower guide element is vertically spaced apart from the upper guide element, wherein an upper portion of the lower guide element includes a curved guide piece; wherein, when the lower protruding structure translates inboard through the curved guide piece and vertically downwards through the lower guide element, the upper protruding structure translates vertically downwards through the upper guide element. The lower guide element includes a glass guide element disposed below the curved guide piece adapted to receive an edge of the glass as the lower protruding structure translates vertically downwards through the lower guide element. When at least a portion of the edge of the glass is received in the glass guide element and the upper protruding structure translates vertically downwards and out of a bottom of the upper guide element to coincide with a space defined between the vertically spaced apart lower guide element and upper guide element, the door body is free to be opened/closed with respect to the vehicle. When the lower protruding structure translates vertically upwards through the lower guide element and outboard through the curved guide piece, the upper protruding structure translates vertically upwards through the upper guide element. Optionally, the pillar is a side portion of an exterior frame structure coupled to the door body and surrounding the glass or a glass opening. In the closed configuration, the glass is adapted to sit flush with the exterior panel of the door body. In the closed configuration, the glass is adapted engage a seal coupled to the pillar.

In another illustrative embodiment, the present disclosure provides a vehicle, including: a pillar; an exterior door panel and an interior door panel forming a door body; a glass adapted to extend from a top of the door body in a closed configuration and be disposed within the door body in an open configuration, wherein a lower corner of the glass includes a lower protruding structure and an upper corner of the glass includes an upper protruding structure; an upper guide element adapted to be secured to or formed in the pillar and receive the upper protruding structure; and a lower guide element adapted to be secured to or formed in an interior portion of the door body and receive the lower protruding structure, wherein lower guide element is vertically spaced apart from the upper guide element, wherein an upper portion of the lower guide element includes a curved guide piece; wherein, when the lower protruding structure translates inboard through the curved guide piece and vertically downwards through the lower guide element, the upper protruding structure translates vertically downwards through the upper guide element. The lower guide element includes a glass guide element disposed below the curved guide piece adapted to receive an edge of the glass as the lower protruding structure translates vertically downwards through the lower guide element. When at least a portion of the edge of the glass is received in the glass guide element and the upper protruding structure translates vertically downwards and out of a bottom of the upper guide element to coincide with a space defined between the vertically spaced apart lower guide element and upper guide element, the door body is free to be opened/closed with respect to the vehicle. When the lower protruding structure translates vertically upwards through the lower guide element and outboard through the curved guide piece, the upper protruding structure translates vertically upwards through the upper guide element. Optionally, the pillar is a side portion of an exterior frame structure coupled to the door body and surrounding the glass or a glass opening. In the closed configuration, the glass is adapted to sit flush with the exterior panel of the door body. In the closed configuration, the glass is adapted engage a seal coupled to the pillar.

In a further illustrative embodiment, the present disclosure provides a method for actuating a glass of a vehicle, the method including: translating a lower corner of the glass inboard with respect to an exterior door panel and an interior panel forming a door body; translating the lower corner vertically downwards and into the door body; and translating an upper corner of the glass vertically downwards and into the door body. The glass is adapted to extend from a top of the door body in a closed configuration and be disposed within the door body in an open configuration. A lower corner of the glass includes a lower protruding structure and an upper corner of the glass includes an upper protruding structure. The upper protruding structure is received in an upper guide element adapted to be secured to or formed in a pillar of the vehicle. The lower protruding structure is received in a lower guide element adapted to be secured to or formed in an interior portion of the door body, wherein lower guide element is vertically spaced apart from the upper guide element, wherein an upper portion of the lower guide element includes a curved guide piece. When the lower protruding structure translates inboard through the curved guide piece and vertically downwards through the lower guide element, the upper protruding structure translates vertically downwards through the upper guide element. The lower guide element includes a glass guide element disposed below the curved guide piece adapted to receive an edge of the glass as the lower protruding structure translates vertically downwards through the lower guide element. When at least a portion of the edge of the glass is received in the glass guide element and the upper protruding structure translates vertically downwards and out of a bottom of the upper guide element to coincide with a space defined between the vertically spaced apart lower guide element and upper guide element, the door body is free to be opened/closed with respect to the vehicle. When the lower protruding structure translates vertically upwards through the lower guide element and outboard through the curved guide piece, the upper protruding structure translates vertically upwards through the upper guide element. Optionally, the pillar is a side portion of an exterior frame structure coupled to the door body and surrounding the glass or a glass opening. In the closed configuration, the glass is adapted to sit flush with the exterior panel of the door body.

### BRIEF DESCRIPTION OF THE DRAWINGS

The present disclosure is illustrated and described with reference to the various drawings, in which like reference numbers are used to denote like assembly components and/or method steps, as appropriate, and in which:

FIG. 1 is a planar view of one illustrative embodiment of the tailgate assembly and flush droppable glass assembly of the present disclosure, with the associated glass in a closed configuration and the tailgate assembly in a closed configuration;

FIG. 2 is another planar view of one illustrative embodiment of the tailgate assembly and flush droppable glass assembly of the present disclosure, with the associated glass in a partially open configuration and the tailgate assembly in the closed configuration;

FIG. 3 is further planar view of one illustrative embodiment of the tailgate assembly and flush droppable glass assembly of the present disclosure, with the associated glass in an open configuration and the tailgate assembly in the closed configuration;

FIG. 4 is further planar view of one illustrative embodiment of the tailgate assembly and flush droppable glass assembly of the present disclosure, with the associated glass in the open configuration and the tailgate assembly in a partially open configuration;

FIG. 5 is a perspective view of one illustrative embodiment of the tailgate assembly and flush droppable glass assembly of the present disclosure, with the associated glass in a closed configuration and the tailgate assembly in a closed configuration;

FIG. 6 is another perspective view of one illustrative embodiment of the tailgate assembly and flush droppable glass assembly of the present disclosure, with the associated glass in a partially open configuration and the tailgate assembly in the closed configuration;

FIG. 7 is further perspective view of one illustrative embodiment of the tailgate assembly and flush droppable glass assembly of the present disclosure, with the associated glass in an open configuration and the tailgate assembly in a partially open configuration;

FIG. 8 is a perspective view of one illustrative embodiment of the flush droppable glass assembly of the present disclosure, highlighting the associated guide elements, with the associated glass in a closed configuration and the tailgate assembly in a closed configuration;

FIG. 9 is another perspective view of one illustrative embodiment of the flush droppable glass assembly of the present disclosure, highlighting the associated guide elements, with the associated glass in a partially open configuration and the tailgate assembly in the closed configuration;

FIG. 10 is a further perspective view of one illustrative embodiment of the flush droppable glass assembly of the present disclosure, highlighting the associated guide elements, with the associated glass in an open configuration and the tailgate assembly in the closed configuration; and

FIG. 11 is a series of perspective views of a cargo carrier assembly used in conjunction with the flush droppable glass assembly of the present disclosure.

All figures are shown with appropriate transparency to reveal internal structures where helpful.

### DETAILED DESCRIPTION

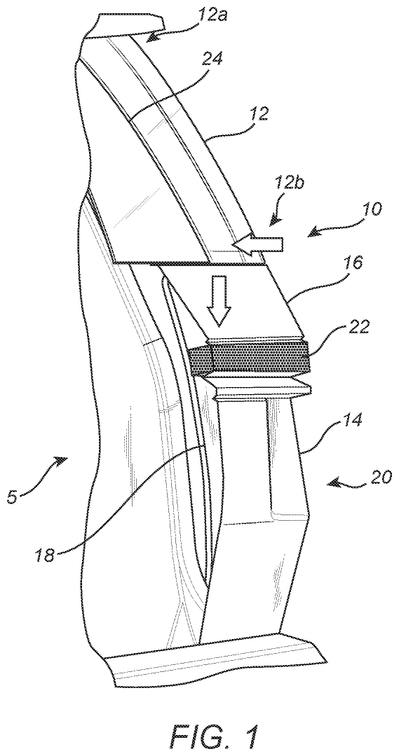

FIG. 1 is a planar view of one illustrative embodiment of the tailgate assembly and flush droppable glass assembly (collectively, the assembly 10) of the present disclosure, with the associated glass 12 in a closed configuration and the tailgate 14 in a closed configuration. As illustrated, the tailgate 14 is pivotably attached to the vehicle 5 and is configured to be pivoted outwards and downwards to be opened. It will be readily apparent to those of ordinary skill in the art that other hinged arrangements could be used equally, such as a door 14 that is configured to be pivoted outwards and sideways to be opened, or a door 14 that is configured to be pivoted outwards and upwards to be opened. In the closed configuration, the glass 12 is substantially flush with an exterior panel 16 of the tailgate 14. The tail gate also includes an interior panel 18. Together, the exterior panel 16 and the interior panel 18 form a body 20 of the tailgate 14 in which the glass 12 is disposed and concealed when opened.

When the glass 12 is opened, it is desirable that the various lighting modules 22 and other components disposed partially or wholly within the body 20 of the tailgate 14 adjacent to/through the exterior panel 16 do not interfere with the movement of the glass 12 within the body 20 of the tailgate 14, and it is desirable that the glass 12 does not have to be inset inboard from the exterior panel 16, thereby sacrificing the flush appearance. To accomplish this, the top corner 12a of the glass 12 is pivotably and vertically translatably coupled to the pillar 24 disposed adjacent to the tailgate 14. The bottom corner 12b of the glass 12 is pivotably and horizontally and vertically translatably coupled to the interior of the body 20 and is configured to first translate inboard when being opened and then translate vertically downwards, such that the glass 12 is disposed and concealed within the body 20 of the tailgate 14 between the exterior panel 16 and the interior panel 18. Thus, the bottom corner 12b of the glass 12, which sits flush with the exterior panel 16 of the body 20 of the tailgate 14 when the glass 12 is closed, is first pulled horizontally inboard to clear the belt line sheet metal, associated seal flange, and the various lighting modules 22 and other components disposed partially or wholly within the body 20 of the tailgate 14 when the glass 12 is opened. Then, the glass 12 is translated vertically downwards into the body 20 of the tailgate 14, where it is concealed. The associated passage space (not illustrated) disposed at the bottom of the window opening between the exterior panel 16 and the interior panel 18, through which the glass 12 passes, may be covered with any type of mechanical door, baffle, clip in cover, etc. (not illustrated).

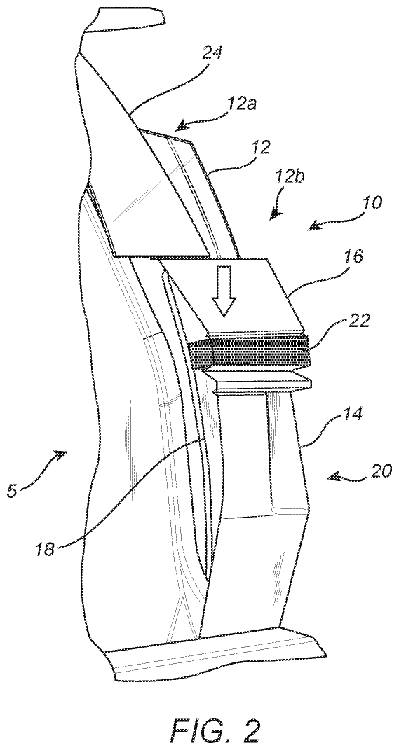

FIG. 2 is another planar view of one illustrative embodiment of the tailgate assembly and flush droppable glass assembly (collectively, the assembly 10) of the present disclosure, with the associated glass 12 in a partially open configuration and the tailgate 14 in the closed configuration. The bottom corner 12b (FIG. 1) of the glass 12 is already pulled horizontally inboard to clear the belt line sheet metal, associated seal flange, and the various lighting modules 22 and other components disposed partially or wholly within the body 20 of the tailgate 14. The glass 12 is translated partially vertically downwards into the body 20 of the tailgate 14, where it is partially concealed. This partially closed configuration may be utilized during vehicle operation.

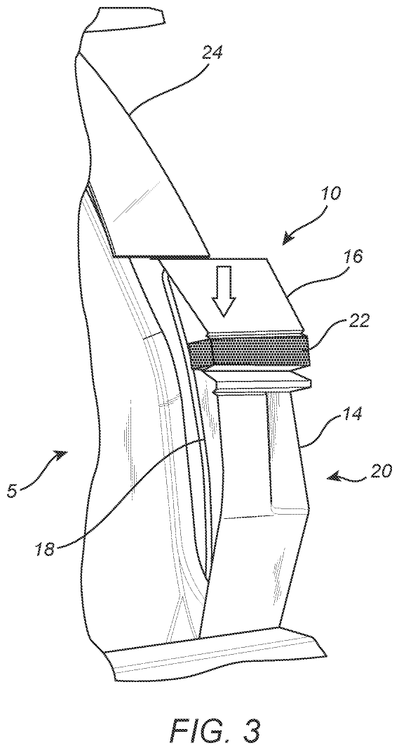

FIG. 3 is further planar view of one illustrative embodiment of the tailgate assembly and flush droppable glass assembly (collectively, the assembly 10) of the present disclosure, with the associated glass 12 (FIGS. 1 and 2) in an open configuration and the tailgate 14 in the closed configuration. The bottom corner 12b (FIG. 1) of the glass 12 is already pulled horizontally inboard to clear the belt line sheet metal, associated seal flange, and the various lighting modules 22 and other components disposed partially or wholly within the body 20 of the tailgate 14. The glass 12 is translated fully vertically downwards into the body 20 of the tailgate 14, where it is fully concealed. This fully closed configuration may be utilized during vehicle operation.

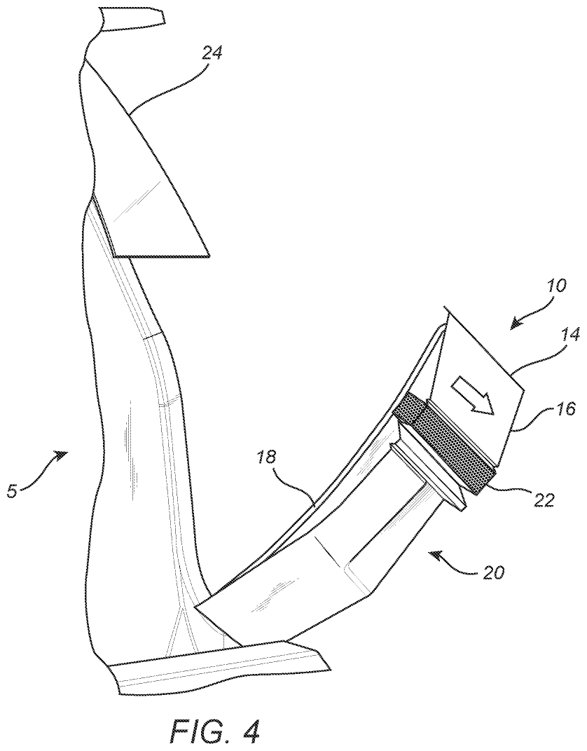

FIG. 4 is further planar view of one illustrative embodiment of the tailgate assembly and flush droppable glass assembly (collectively, the assembly 10) of the present disclosure, with the associated glass 12 (FIGS. 1 and 2) in the open configuration and the tailgate 14 in a partially open configuration. The bottom corner 12b (FIG. 1) of the glass 12 is already pulled horizontally inboard to clear the belt line sheet metal, associated seal flange, and the various lighting modules 22 and other components disposed partially or wholly within the body 20 of the tailgate 14. The glass 12 is translated fully vertically downwards into the body 20 of the tailgate 14, where it is fully concealed. Further, the tailgate 14 is pivoted partially outwards and downwards. In a fully open configuration, the tailgate 14 is horizontally disposed.

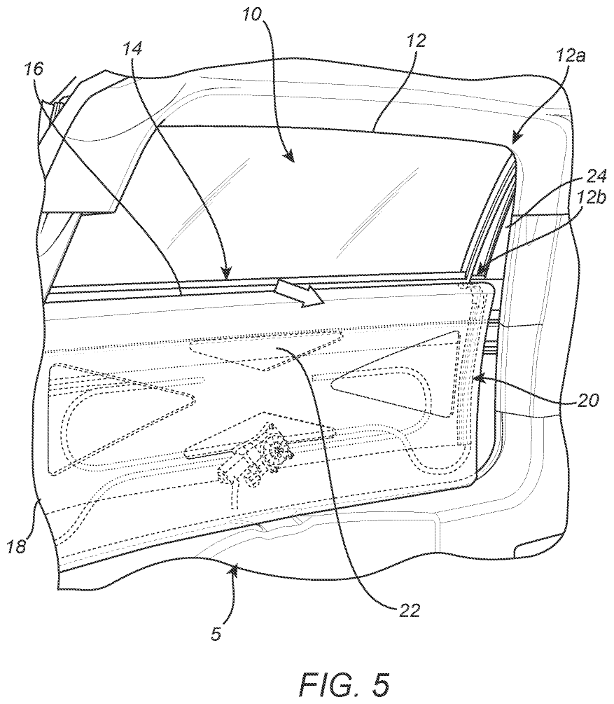

FIG. 5 is a perspective view of one illustrative embodiment of the tailgate assembly and flush droppable glass assembly (collectively, the assembly 10) of the present disclosure, with the associated glass 12 in a closed configuration and the tailgate 14 in a closed configuration. The bottom corner 12b of the glass 12, which sits flush with the exterior panel 16 of the body 20 of the tailgate 14 when the glass 12 is closed, is first pulled horizontally inboard to clear the belt line sheet metal, associated seal flange, and the various lighting modules 22 and other components disposed partially or wholly within the body 20 of the tailgate 14 when the glass 12 is opened. Then, the glass 12 is translated vertically downwards into the body 20 of the tailgate 14, where it is concealed.

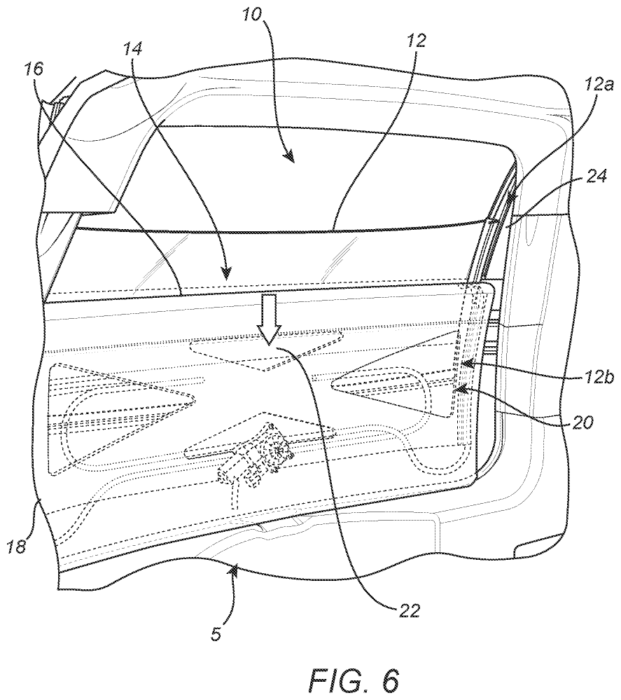

FIG. 6 is another perspective view of one illustrative embodiment of the tailgate assembly and flush droppable glass assembly (collectively, the assembly 10) of the present disclosure, with the associated glass 12 in a partially open configuration and the tailgate 14 in the closed configuration. The bottom corner 12b of the glass 12 is already pulled horizontally inboard to clear the belt line sheet metal, associated seal flange, and the various lighting modules 22 and other components disposed partially or wholly within the body 20 of the tailgate 14. The glass 12 is translated partially vertically downwards into the body 20 of the tailgate 14, where it is partially concealed. This partially closed configuration may be utilized during vehicle operation.

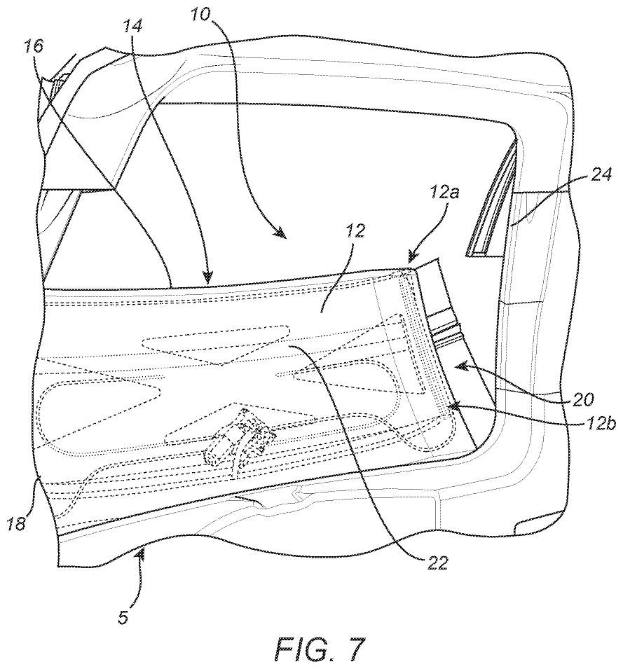

FIG. 7 is further perspective view of one illustrative embodiment of the tailgate assembly and flush droppable glass assembly (collectively, the assembly 10) of the present disclosure, with the associated glass 12 in an open configuration and the tailgate 14 in a partially open configuration. The bottom corner 12b of the glass 12 is already pulled horizontally inboard to clear the belt line sheet metal, associated seal flange, and the various lighting modules 22 and other components disposed partially or wholly within the body 20 of the tailgate 14. The glass 12 is translated fully vertically downwards into the body 20 of the tailgate 14, where it is fully concealed. Further, the tailgate 14 is pivoted partially outwards and downwards. In a fully open configuration, the tailgate 14 is horizontally disposed.

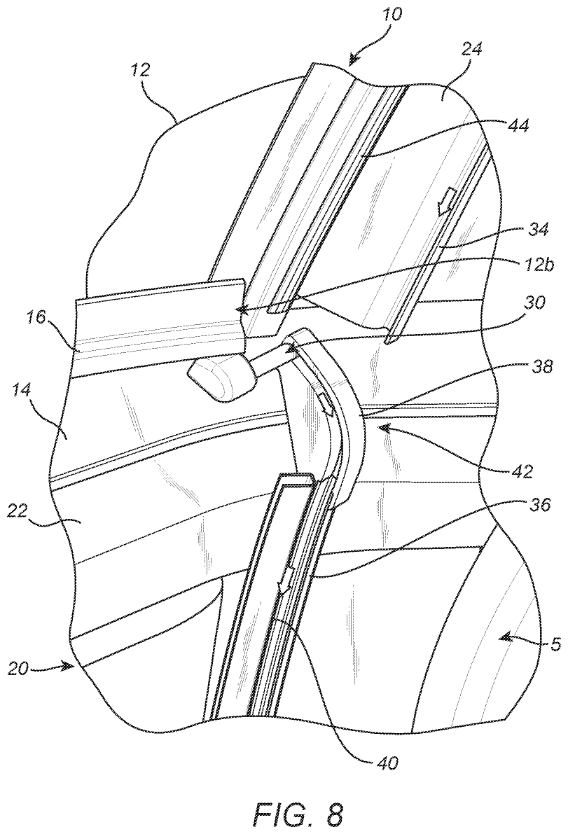

FIG. 8 is a perspective view of one illustrative embodiment of the flush droppable glass assembly 10 of the present disclosure, highlighting the associated guide elements 34, 36, 38, 40, with the associated glass 12 in a closed configuration and the tailgate 14 in a closed configuration. The exterior door panel 16 and the interior door panel 18 (FIGS. 1-7) form the door body 20. The glass 12 is adapted to extend from the top of the door body 20 in a closed configuration and be disposed within the door body 20 in an open configuration. The lower corners 12b of the glass 12 each include a lower protruding structure 30 and the upper corners 12a (FIGS. 1, 2, and 5-7) of the glass 12 each include an upper protruding structure (not illustrated). An upper guide element 34 is secured to or formed in each pillar 24 of the vehicle 5 and receives the associated upper protruding structure. In the embodiment illustrated, the pillars 24 are the D-pillars of the vehicle 5, although other pillars or structural members could be used equally. Each upper guide element 34 is a U-shaped channel that vertically traverses the associated pillar 24 and constrains movement of the associated upper protruding structure, which is allowed to translate vertically along the pillar 24. A lower guide element 36 is secured to or formed in an interior portion of each side of the door body 20 and receives the associated lower protruding structure 30. Each lower guide element 36 is a U-shaped channel that vertically traverses the associated interior side of the door body 20 and constrains movement of the associated lower protruding structure 30, which is allowed to translate vertically along the interior side of the door body 20. Each lower guide element 36 is vertically spaced apart from the corresponding upper guide element 34. The upper portion of the lower guide element 36 includes a curved guide piece 38, which is a U-shaped channel that horizontally and vertically traverses the associated interior side of the door body 20 and constrains movement of the associated lower protruding structure 30, which is allowed to translate horizontally and vertically along the interior side of the door body 20. Thus, the lower protruding structure 30 translates inboard through the curved guide piece 38 and vertically downwards through the lower guide element 36, while the upper protruding structure translates vertically downwards through the upper guide element 34. The lower guide element 36 includes a glass guide element 40, which is also a U-shaped channel, disposed below the curved guide piece 38 adapted to receive an edge of the glass 12 as the lower protruding structure 30 translates vertically downwards through the lower guide element 36. The lower guide element 36 and the glass guide element 40 may be separate components or integrally formed.

When at least a portion of the edge of the glass 12 is received in the glass guide element 40 and the upper protruding structure translates vertically downwards and out of a bottom of the upper guide element 34 to coincide with a space 42 defined between the vertically spaced apart lower guide element 36 and upper guide element 34, the door body 20 is free to be opened/closed with respect to the vehicle 5. When the lower protruding structure 30 translates vertically upwards through the lower guide element 36 and outboard through the curved guide piece 38, the upper protruding structure translates vertically upwards through the upper guide element 34. Optionally, the pillar 24 is a side portion of an exterior frame structure coupled to the door body 20 and surrounding the glass 20 and glass opening. In the closed configuration, the glass 12 is adapted to sit flush with the exterior panel 16 of the door body 20 engage a seal 44 coupled to the pillar 24.

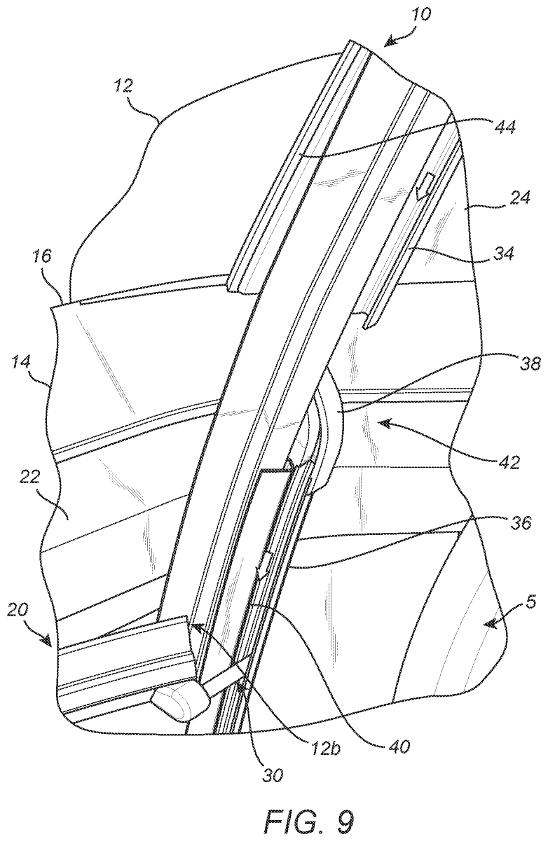

FIG. 9 is another perspective view of one illustrative embodiment of the flush droppable glass assembly 10 of the present disclosure, highlighting the associated guide elements 34, 36, 38, 40, with the associated glass 12 in a partially open configuration and the tailgate 14 in the closed configuration. Again, the exterior door panel 16 and the interior door panel 18 (FIGS. 1-7) form the door body 20. The glass 12 is adapted to extend from the top of the door body 20 in a closed configuration and be disposed within the door body 20 in an open configuration. The lower corners 12b of the glass 12 each include a lower protruding structure 30, such as a pin, tab, or slider, and the upper corners 12a (FIGS. 1, 2, and 5-7) of the glass 12 each include an upper protruding structure (not illustrated), such as a pin, tab, or slider. The upper guide element 34 is secured to or formed in each pillar 24 of the vehicle 5 and receives the associated upper protruding structure. In the embodiment illustrated, the pillars 24 are the D-pillars of the vehicle 5, although other pillars or structural members could be used equally. Each upper guide element 34 is a U-shaped channel that vertically traverses the associated pillar 24 and constrains movement of the associated upper protruding structure, which is allowed to pivot and translate vertically along the pillar 24. The lower guide element 36 is secured to or formed in an interior portion of each side of the door body 20 and receives the associated lower protruding structure 30. Each lower guide element 36 is a U-shaped channel that vertically traverses the associated interior side of the door body 20 and constrains movement of the associated lower protruding structure 30, which is allowed to pivot and translate vertically along the interior side of the door body 20. Each lower guide element 36 is vertically spaced apart from the corresponding upper guide element 34. The upper portion of the lower guide element 36 includes the curved guide piece 38, which is a U-shaped channel that horizontally and vertically traverses the associated interior side of the door body 20 and constrains movement of the associated lower protruding structure 30, which is again allowed to pivot and translate horizontally and vertically along the interior side of the door body 20. Thus, the lower protruding structure 30 translates inboard through the curved guide piece 38 and vertically downwards through the lower guide element 36, while the upper protruding structure translates vertically downwards through the upper guide element 34. The lower guide element 36 includes a glass guide element 40, which is also a U-shaped channel, disposed below the curved guide piece 38 adapted to receive an edge of the glass 12 as the lower protruding structure 30 translates vertically downwards through the lower guide element 36. The lower guide element 36 and the glass guide element 40 may be separate components or integrally formed.

When at least a portion of the edge of the glass 12 is received in the glass guide element 40 for support and the upper protruding structure translates vertically downwards and out of a bottom of the upper guide element 34 to coincide with the space 42 defined between the vertically spaced apart lower guide element 36 and upper guide element 34, the door body 20 is free to be opened/closed with respect to the vehicle 5. When the lower protruding structure 30 translates vertically upwards through the lower guide element 36 and outboard through the curved guide piece 38, the upper protruding structure translates vertically upwards through the upper guide element 34. Again, in the closed configuration, the glass 12 is adapted to sit flush with the exterior panel 16 of the door body 20 engage the seal 44 coupled to the pillar 24.

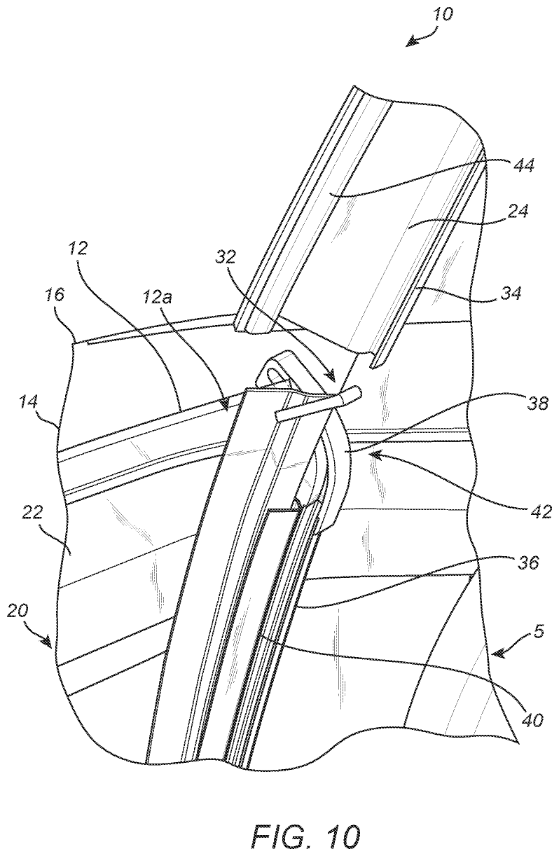

FIG. 10 is a further perspective view of one illustrative embodiment of the flush droppable glass assembly 10 of the present disclosure, highlighting the associated guide elements 34, 36, 38, 40, with the associated glass 12 in an open configuration and the tailgate 14 in the closed configuration. Again, the exterior door panel 16 and the interior door panel 18 (FIGS. 1-7) form the door body 20. The glass 12 is adapted to extend from the top of the door body 20 in a closed configuration and be disposed within the door body 20 in an open configuration. The lower corners 12b (FIGS. 1, 2, and 5-9) of the glass 12 each include a lower protruding structure 30 (FIGS. 8 and 9), such as a pin, tab, or slider, and the upper corners 12a of the glass 12 each include an upper protruding structure 32, such as a pin, tab, or slider. The upper guide element 34 is secured to or formed in each pillar 24 of the vehicle 5 and receives the associated upper protruding structure 32. In the embodiment illustrated, the pillars 24 are the D-pillars of the vehicle 5, although other pillars or structural members could be used equally. Each upper guide element 34 is a U-shaped channel that vertically traverses the associated pillar 24 and constrains movement of the associated upper protruding structure 32, which is allowed to pivot and translate vertically along the pillar 24. The lower guide element 36 is secured to or formed in an interior portion of each side of the door body 20 and receives the associated lower protruding structure 30. Each lower guide element 36 is a U-shaped channel that vertically traverses the associated interior side of the door body 20 and constrains movement of the associated lower protruding structure 30, which is allowed to pivot and translate vertically along the interior side of the door body 20. Each lower guide element 36 is vertically spaced apart from the corresponding upper guide element 34. The upper portion of the lower guide element 36 includes the curved guide piece 38, which is a U-shaped channel that horizontally and vertically traverses the associated interior side of the door body 20 and constrains movement of the associated lower protruding structure 30, which is again allowed to pivot and translate horizontally and vertically along the interior side of the door body 20. Thus, the lower protruding structure 30 translates inboard through the curved guide piece 38 and vertically downwards through the lower guide element 36, while the upper protruding structure 32 translates vertically downwards through the upper guide element 34. The lower guide element 36 includes a glass guide element 40, which is also a U-shaped channel, disposed below the curved guide piece 38 adapted to receive an edge of the glass 12 as the lower protruding structure 30 translates vertically downwards through the lower guide element 36. The lower guide element 36 and the glass guide element 40 may be separate components or integrally formed.

When at least a portion of the edge of the glass 12 is received in the glass guide element 40 for support and the upper protruding structure 32 translates vertically downwards and out of a bottom of the upper guide element 34 to coincide with the space 42 defined between the vertically spaced apart lower guide element 36 and upper guide element 34, the door body 20 is free to be opened/closed with respect to the vehicle 5. When the lower protruding structure 30 translates vertically upwards through the lower guide element 36 and outboard through the curved guide piece 38, the upper protruding structure translates vertically upwards through the upper guide element 34. Again, in the closed configuration, the glass 12 is adapted to sit flush with the exterior panel 16 of the door body 20 engage the seal 44 coupled to the pillar 24.

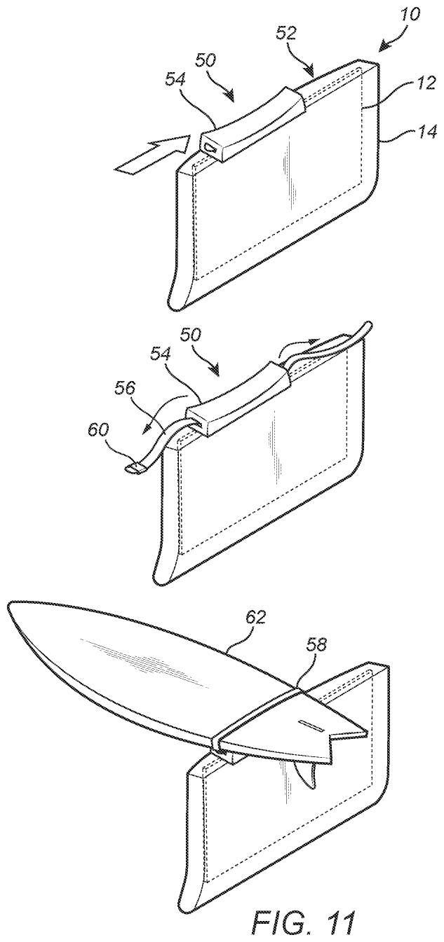

FIG. 11 is a series of perspective views of a cargo carrier assembly 50 used in conjunction with the flush droppable glass assembly 10 of the present disclosure. As illustrated, the top of the tailgate 14 defines a slot or opening 52 into which the glass 12 is retracted. The bottom of the housing 54 of the cargo carrier assembly 50 includes a corresponding boss or other structure that is slid into or otherwise affixed in or adjacent to the slot or opening 52 of the tailgate 14, thereby securing the housing 54 to the top of the tailgate 14, thereby covering at least a portion of the slot or opening 52. Thus, the housing 54 is secured at the top of the tailgate 14 when the glass 12 is open. One or more strap members 56 extend from one or more ends of the housing 54 and is/are adapted to form a loop 58 adjacent to the housing 54. The strap member(s) 56 may be fixed or retractable into the housing 54 when not in use, and a buckle member 60 may be provided to secure the loop 58. The loop 58 may then be used to secure a cargo item 62 to the top of the tailgate 14, with the cargo item 62 protruding into and/or out of the cargo space of the vehicle through the tailgate 14. This is especially useful for large and long items such as a surfboard (as illustrated), skis, a ladder, lumber, and the like.

Although the present disclosure is illustrated and described herein with reference to illustrative embodiments and specific examples of the storage compartment door assembly and perimetral hinge assembly provided, it will be readily apparent to those of ordinary skill in the art that other embodiments and examples may perform similar functions and/or achieve like results. All such equivalent embodiment and examples are within the spirit and scope of the present disclosure and are intended to be covered by the following non-limiting claims for all purposes.

What is claimed is:

1. An assembly for a vehicle, the assembly comprising:
an exterior door panel and an interior door panel forming a door body;
a glass adapted to extend from a top of the door body in a closed configuration and be disposed within the door body in an open configuration, wherein a lower corner of the glass comprises a lower protruding structure and an upper corner of the glass comprises an upper protruding structure;
an upper guide element adapted to be secured to or formed in a pillar of the vehicle and receive the upper protruding structure; and
a lower guide element adapted to be secured to or formed in an interior portion of the door body and receive the lower protruding structure, wherein lower guide element is vertically spaced apart from the upper guide element, wherein an upper portion of the lower guide element comprises a curved guide piece;
wherein, when the lower protruding structure translates inboard through the curved guide piece and vertically downwards through the lower guide element, the upper protruding structure translates vertically downwards through the upper guide element.

2. The assembly of claim 1, wherein the lower guide element comprises a glass guide element disposed below the curved guide piece adapted to receive an edge of the glass as the lower protruding structure translates vertically downwards through the lower guide element.

3. The assembly of claim 2, wherein, when at least a portion of the edge of the glass is received in the glass guide element and the upper protruding structure translates vertically downwards and out of a bottom of the upper guide element to coincide with a space defined between the vertically spaced apart lower guide element and upper guide element, the door body is free to be opened/closed with respect to the vehicle.

4. The assembly of claim 1, wherein, when the lower protruding structure translates vertically upwards through the lower guide element and outboard through the curved guide piece, the upper protruding structure translates vertically upwards through the upper guide element.

5. The assembly of claim 1, wherein the pillar comprises a side portion of an exterior frame structure coupled to the door body and surrounding the glass or a glass opening.

6. The assembly of claim 1, wherein, in the closed configuration, the glass is adapted to sit flush with the exterior panel of the door body.

7. The assembly of claim 1, wherein, in the closed configuration, the glass is adapted engage a seal coupled to the pillar.

8. The assembly of claim 1, further comprising a cargo carrier assembly secured to the top of the door body when the glass is in the closed configuration.

9. A vehicle, comprising:
a pillar;
an exterior door panel and an interior door panel forming a door body;
a glass adapted to extend from a top of the door body in a closed configuration and be disposed within the door body in an open configuration, wherein a lower corner of the glass comprises a lower protruding structure and an upper corner of the glass comprises an upper protruding structure;
an upper guide element adapted to be secured to or formed in the pillar and receive the upper protruding structure; and
a lower guide element adapted to be secured to or formed in an interior portion of the door body and receive the lower protruding structure, wherein lower guide element is vertically spaced apart from the upper guide element, wherein an upper portion of the lower guide element comprises a curved guide piece;
wherein, when the lower protruding structure translates inboard through the curved guide piece and vertically downwards through the lower guide element, the upper protruding structure translates vertically downwards through the upper guide element.

10. The vehicle of claim 9, wherein the lower guide element comprises a glass guide element disposed below the curved guide piece adapted to receive an edge of the glass as the lower protruding structure translates vertically downwards through the lower guide element.

11. The vehicle of claim 10, wherein, when at least a portion of the edge of the glass is received in the glass guide element and the upper protruding structure translates vertically downwards and out of a bottom of the upper guide element to coincide with a space defined between the vertically spaced apart lower guide element and upper guide element, the door body is free to be opened/closed with respect to the vehicle.

12. The vehicle of claim 9, wherein, when the lower protruding structure translates vertically upwards through the lower guide element and outboard through the curved guide piece, the upper protruding structure translates vertically upwards through the upper guide element.

13. The vehicle of claim 9, wherein the pillar comprises a side portion of an exterior frame structure coupled to the door body and surrounding the glass or a glass opening.

14. The vehicle of claim 9, wherein, in the closed configuration, the glass is adapted to sit flush with the exterior panel of the door body.

15. The vehicle of claim 9, wherein, in the closed configuration, the glass is adapted engage a seal coupled to the pillar.

16. A method for actuating a glass of a vehicle, the method comprising:
translating a lower corner of the glass inboard with respect to an exterior door panel and an interior panel forming a door body;
translating the lower corner vertically downwards and into the door body; and
translating an upper corner of the glass vertically downwards and into the door body.

17. The method of claim 16, wherein the glass is adapted to extend from a top of the door body in a closed configuration and be disposed within the door body in an open configuration.

18. The method of claim 16, wherein:
a lower corner of the glass comprises a lower protruding structure and an upper corner of the glass comprises an upper protruding structure;
the upper protruding structure is received in an upper guide element adapted to be secured to or formed in a pillar of the vehicle; and
the lower protruding structure is received in a lower guide element adapted to be secured to or formed in an interior portion of the door body, wherein lower guide element is vertically spaced apart from the upper guide element, wherein an upper portion of the lower guide element comprises a curved guide piece;
wherein, when the lower protruding structure translates inboard through the curved guide piece and vertically downwards through the lower guide element, the upper protruding structure translates vertically downwards through the upper guide element.

19. The method of claim 18, wherein the lower guide element comprises a glass guide element disposed below the curved guide piece adapted to receive an edge of the glass as the lower protruding structure translates vertically downwards through the lower guide element.

20. The method of claim 19, wherein, when at least a portion of the edge of the glass is received in the glass guide element and the upper protruding structure translates vertically downwards and out of a bottom of the upper guide element to coincide with a space defined between the vertically spaced apart lower guide element and upper guide element, the door body is free to be opened/closed with respect to the vehicle.

21. The method of claim 18, wherein, when the lower protruding structure translates vertically upwards through the lower guide element and outboard through the curved guide piece, the upper protruding structure translates vertically upwards through the upper guide element.

22. The method of claim 18, wherein the pillar comprises a side portion of an exterior frame structure coupled to the door body and surrounding the glass or a glass opening.

23. The method of claim 17, wherein, in the closed configuration, the glass is adapted to sit flush with the exterior panel of the door body.
